(19) United States
(12) Patent Application Publication
(10) Pub. No.: US 2024/0386559 A1
(43) Pub. Date: Nov. 21, 2024

(54) CONSTRUCTING A SUBJECT MODEL USING OBSCURED OBJECT TRACKING FROM VIDEO DATA FOR DETERMINATION OF DEVELOPMENTAL ABERRATIONS

(71) Applicant: HB Innovations, Inc., Los Angeles, CA (US)

(72) Inventors: Peter Fornell, Los Angeles, CA (US); Borislav Ristic, JR., Los Angeles, CA (US); Christopher Laine, Los Angeles, CA (US); Karthik Aroor, Los Angeles, CA (US)

(73) Assignee: HB Innovations, Inc., Los Angeles, CA (US)

(21) Appl. No.: 18/199,213

(22) Filed: May 18, 2023

(51) Int. Cl. G06T 7/00; G06F 21/62; G06T 7/246; G06T 7/73; G06V 10/776; G06V 20/40; G06V 40/10

(52) U.S. Cl. CPC G06T 7/0014; G06F 21/6254; G06T 7/248; G06T 7/74; G06V 10/776; G06V 20/41; G06V 40/10; G06T 2207/10016; G06T 2207/20081; G06T 2207/30004; G06T 2207/30196; G06T 2207/30204; G06V 2201/03

(57) ABSTRACT

A method of data abstraction and anonymization of video data includes identifying and estimating locations of reference points of a human subject in a sequence of video images captured of the subject over time. The method further includes improving the accuracy of the estimated locations by tracking changes in the sequence of video images using object detection and known relationships with other reference points. The method also includes abstracting and anonymizing the video data by translating the locations of the known and established reference points into a coordinate space of a coordinate system to generate time sequenced coordinates for the reference points including time sequenced change

### TECHNOLOGY

The present disclosure is directed to subject modeling from video data for determination of developmental aberrations that may include establishing markers in obscured objects to track deviations in movement patterns over time.

### BACKGROUND

As capabilities to extract information from a video stream are ever increasing, the cost and capacity to store it is becoming unmanageable. Also, increasing concerns for privacy and safe storage of video are making consumers more hesitant to use video services. Privacy laws are becoming significantly more strict, such as GDPR in Europe and CPPA in California, making the ability to store video for analysis, and the potential liability to do so, factors affecting an organization's ability to create new capabilities for off-line video analytics and population studies.

Analyzing video of infants and children over a period of time is a ground-breaking tool in the diagnosis of illness, conditions and developmental abnormalities. Many symptoms can be detected at a much earlier stage, given the ability to monitor the child. As an example, autism is generally not diagnosed until 2 years of age and requires a trained physician. This also assumes caregivers are aware a condition may be present and take the child to a professional, which is often not the case and a diagnosis is not established until much later. It is clear that the symptoms of the condition are present from birth, but are minor and difficult to detect. If having video recordings of behavior, such as turning away when a parent gets close or reactions to other external stimuli, a more comprehensive picture can be assembled as such behavior can be subtle and infrequent.

Sub-VGA resolution at 15 fps uses around 10 MB/min without major compression. Thus, 7 GB of storage per 12 hours of video is required. However, storing this amount of video at scale is not commercially viable. Without the ability to do so, however, prevents post analysis and large scale population studies. Alternatively, regular compression techniques (e.g. H.264/265) cannot be used, as the relevant information is in minute changes of the scene and important information is lost as the analysis is often looking for very small changes, such as 1 mm of change for breathing. Alternatively, event based recording can be used to reduce the amount of video required to be handled and stored, but knowledge of the events the to be analyzed in the video may not be known until a later time when analysis identifies patterns of interest, it is undesirable to cut out potentially important data.

### SUMMARY

In various embodiments, the present disclosure provides systems and methods configured to establish markers in obscured objects to track deviations in patterns to determine developmental aberrations, utilizing an abstraction model over a period of time. The systems and methods may operate in an unrestricted environment as well as on a large population. According to some embodiments, the systems and methods may provide the added benefit of being able to anonymize the data.

In one aspect, systems and methods described herein may be utilized to generate subject models. For example, the system may be configured to analyze image data of a subject and determine known reference points, such as the eyes, nose, mouth. Using the known reference points, a working model is constructed using known relationships between and/or among reference points. Using these reference points, changes in the scene are used to estimate and establish locations of other reference points, such as feet, knees, hips, hands, etc. that are not visible. Using multiple detection estimations, the working model can be improved over time to establish precise location by averaging the estimated locations of the estimated reference points and correlating them to the known relationships.

In one example, by using object detection and known reference points, an object's location in the scene becomes irrelevant when it is known that the object of interest is a particular type of subject, such as an infant or child. Hence, it becomes unnecessary to control the location of the camera and the object. In some embodiments, if there is a need to capture images of multiple subjects, the system and methods may incorporate face recognition to distinguish between the different subjects to label the data and more precisely direct the known relationships.

In a further or another example, known objects in the scene, such as a sleep sack or other objects adjacent to the subject having known dimensions, can be utilized to calculate absolute length without having a depth or stereo image. For example, by establishing length of such known objects in the scene any other dimension can now be calculated.

In any of the above or another example, the system may utilize a subject specification. The subject specification may include one or more object detection algorithms and/or define data for use by one or more object detection algorithms, such as identification of type of subject, size of the subject, reference point, and known relationships. Using the subject specification and object detection, which, in some embodiments, may be a component of the subject specification, the system may process an image frame and identify known reference points (sufficiently visible reference points) in the image. Some known reference points may have approximately fixed known relationships that only change minutely as the child grows and may be used to determine distances or scale of the image for use with known relationships. In some embodiments, non-subject objects having known dimensions may be used to determine image scale.

In any of the above or another example, using these known relationships, reference points that are not clearly visible may be estimated. These estimated reference points may be designated as points of interest (reference POI). In one example, the accuracy of the estimated reference points may be incrementally improved in subsequent image frames as the subject moves. Thus, by collecting multiple samples of what is believed to be the object, statistical methods may be used to establish its absolute location in reference to other reference points. In a further example, once the reference POI has been established, it can be converted to an established reference point. For example, by establishing estimated reference points, other reference points can be estimated using known relationships, such as the location of the elbows where location of shoulders and/or hands are known or established. If the elbow or a reflection of the elbow becomes visible in an image frame, the location of the elbow may be validated and the estimated reference point, established or reference POI, may be converted to a known reference point. The process can utilize elements in the video images together with known relationships to identify an estimated reference point. For example, a protrusion under a blanket may correspond to a known relationships of a foot to known reference points and/or, in some instances, estimated reference point may be used to estimate a region as a reference POI corresponding to a foot. The system may therefore track movements while estimating, establishing, and validating reference points to develop a working model of the subject that captures movements and orientation over time.

In any of the above or another example, the system is configured to transmit and/or store the model data corresponding to the tracked movements of the known reference points and estimated reference points. In one configuration, the system transmits and/or stores the data as change coordinates (change coordinates), instead of the video, for analysis or storage for subsequent analysis. Various change coordinates methodologies may be employed, such as coordinates in an established grid system, for example the pixels of the sensor, or vector based. Beneficially, by sending change coordinates, the amount of data is reduced by an order of magnitude without loss of information. In some embodiments, data may be further reduced by only transmitting change coordinates when a change has occurred.

In any of the above or another example, a subject model is constructed of the subject using the coordinates of the identified tracked reference points. This model may then be used for analytics, including animation and long-term tracking of movements, growth and behavior.

In one aspect, a method of data abstraction and anonymization of video data includes identifying and estimating locations of reference points of a human subject in a sequence of video images captured of the subject over time. The method may further include improving the accuracy of the estimated locations by tracking changes in the sequence of video images using object detection and known relationships with other reference points. The method may also include abstracting and anonymizing the video data by translating the locations of the known and established reference points into a coordinate space of a coordinate system to generate time sequenced coordinates for the reference points including time sequenced change.

In one example, the method includes transmitting the time sequence change coordinates over a network for analysis and/or storage. In one configuration, the time sequenced change coordinates comprise coordinates of the reference point within the coordinate space at specified times within the time sequence. In one configuration, the time sequenced change coordinates comprise a translocation instructions within the coordinate system space from a prior coordinate location with the coordinate space.

In any of the above examples or another example, the coordinate system comprises a grid system, a vector based system, or a grid system is based on pixels of an image sensor, digital camera, or digital image.

In any of the above examples or another example, the method may include constructing a subject model from the time sequenced change coordinates. In a further example, the subject model comprises a stick figure abstraction. In another or a further example, the method may include analyzing the subject model to track movements, growth, behavior, or combination thereof. In a further or another example, the method may include applying AI or machine learning to subject models of a population of subjects for early detection of conditions.

In any of the above examples or another example, the method may include applying confidence scores to the estimated locations of the estimated reference points.

In another aspect, a machine-readable medium carrying machine readable instructions, which when executed by a processor of a machine, causes the machine to carry out the above method including any combination of examples thereof.

In still another aspect, a system configured for data abstraction and anonymization of video data may include a processor and memory that when executed by the processor cause the processor to perform the operations comprising identifying, with a model generator, locations of one or more known reference points of a human subject that are visible in a video image frames capture of the subject; estimating a location of an obscured reference point of interest with respect to the subject based on one or both of a known relationship with a known reference point or object detection; converting the obscured reference point of interest to an established reference point by improving the accuracy of the estimated location by tracking changes in subsequently captured video image frames of the subject and applying one or more statistical methods to establish the estimated location relative to one or more other established location reference points, known reference points, or both; translating the identified and estimated locations of the known and established reference points into a coordinate space of a coordinate system to generate time sequenced coordinates of the reference points; and constructing, with a model analysis unit, a subject model from the time sequenced coordinates of the reference points.

In one example, the time sequenced coordinates include time sequenced change coordinates.

In a further example, the operations may further include transmitting the time sequence change coordinates over a network for analysis and/or storage. In one example, the time sequenced change coordinates include coordinates of the reference point within the coordinate space at specified times within the time sequence. In one example, the time sequenced change coordinates include a translocation instructions within the coordinate system space from a prior coordinate location with the coordinate space.

In any of the above examples or another example, the operations further include estimating locations for a plurality of obscured reference points of interest based on known relationships with known reference points, established reference points, or both; and translating the estimated locations of the estimated reference points of interest into time sequenced coordinates with the coordinate space comprising time sequenced change coordinates.

In any of the above examples or another example, the coordinate system includes a grid system or a vector based system.

In any of the above examples or another example, the coordinate system includes a grid system and the grid system is based on pixels of an image sensor, digital camera, or digital image.

In any of the above examples or another example, the operations further include analyzing the subject model to track movements, growth, behavior, or combination thereof.

In any of the above examples or another example, the operations further include applying AI or machine learning to subject models of a population of subjects for early detection of conditions.

In any of the above examples or another example, the operations further include identifying a non-subject object having a known dimension in the video image frames to scale the image frames.

In any of the above examples or another example, the subject model comprises a stick figure abstraction.

In any of the above examples or another example, the one or more statistical methods includes averaging the estimated location as correlated to the known relationships.

In any of the above examples or another example, the operations further include applying confidence scores to the estimated locations of the established reference points, estimated reference points of interest, or both.

### DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 is a schematic of a system for subject modeling and data abstraction according to various embodiments described herein;

FIG. 2 illustrates an aspect of generating a working model of a subject according to various embodiments described herein;

FIG. 3 illustrates an aspect of generating estimated reference points with respect to FIG. 2 incorporating further known relationships according to various embodiments described herein;

FIG. 4 illustrates a change coordinate methodology according to various embodiments described herein;

FIG. 5 illustrates a change coordinate methodology according to various embodiments described herein;

FIG. 6 illustrates a change coordinate methodology according to various embodiments described herein;

FIG. 7 illustrates a method according to various embodiments describe herein;

FIG. 8 illustrates a method according to various embodiments described herein; and

FIG. 9 is a schematic diagram of a machine in the form of a computer system within which a set of instructions, when executed, may cause the machine to provide subject modeling and abstraction according to various embodiments described herein.

### DESCRIPTION

The present description describes various embodiments of systems and methods configured for marker establishment in obscured objects from video data. In one example, the system and methods are configured for marker establishment implemented in an abstracted subject model environment to track obscured objects in the video data. In one example, subject modeling includes establishment of markers over time to track obscured objects. In one example, subject modeling to track obscured objects is informed by establishment of markers over time. In one example, subject modeling is utilized for movement tracking of a subject over time for identification of developmental aberrations. For example, the systems and methods may include generation and analysis of a subject model as described herein for determination of developmental aberrations. The systems and methods described herein may further be utilized to significantly reduce volume of data transmitted, stored, and analyzed compared to captured video data. In some examples, the systems and methods according to the above or elsewhere herein may be applied in an anonymized environment where the subject model data is anonymized.

The present description describes various embodiments of systems and methods configured for video data reduction and/or anonymization of video data at the same time via abstraction. The inventive techniques may be applied to video captured over time of an infant subject positioned in a crib. In some embodiments, the systems and methods may be applied to capture and analyze a subject undergoing global movement as well as local movement relative to a camera that captures image frames of the subject, such as a subject resting on a platform of a crib that is undergoing movement relative to the camera.

The video data may be analyzed by the systems and methods to identify movements, orientations, conditions, or for other applications. In some embodiments, the data may be analyzed to detect small movements such as breathing and/or physical conditions such as autism. The video data and the systems and methods described herein may also be applied to population studies and/or fed to AI algorithms to identify or analyze movements or orientations, diagnose conditions, or the like. In some embodiments, the system and methods may be configured to breakdown movements of a subject via application of abstraction techniques to construct a subject model of movements. The abstraction may, for example, also anonymize the video data, thereby addressing privacy concerns. In some embodiments, the systems and methods may be used to generate a subject model that includes a “stick figure” abstraction to reduce data storage while being able to perform analytics on the resultant model and the anonymized subject(s).

Analysis of video taken of infants and children over time may be a powerful tool for identification and diagnosis of conditions such as diseases, illnesses, and developmental abnormalities. However, as infants and children many times are obfuscated by clothing, blankets, pajamas, etc., it may be difficult to rely on the ability of the video analysis to visually detect objects of interests, such as a foot or a knee, with precision.

According to various embodiments, the present disclosure describes systems and methodologies for generating models of subjects utilizing video data and/or analyzing models of subjects obtained from video data to track movements and/or growth even when parts of the subject may be obfuscated. In one embodiment, the system is configured to build a working model based on reference points and known relationships, identify points of interest (reference POI) and correlate the reference POI to known relationships. The system may be configured to build confidence in reference POI estimates over time when reference POI of interest becomes visible or established and use that confidence in future reference POI identifications for other reference points. The reference points may be translated into a coordinate system within the working model or for rendering in a subject model for analysis. The system may be configured to use object detection of known objects having known dimensions and extrapolating those known dimensions to estimate dimensions in the coordinate system for strengthening known relationships calculations via a 2-dimension image environment.

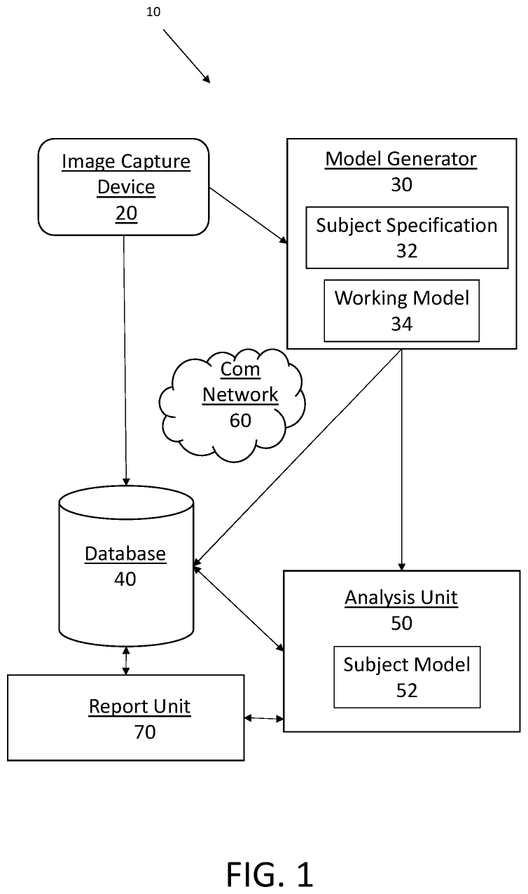

With reference to FIG. 1, according to various embodiments, the methodologies described herein may include or be executed by a system 10 configured to analyze video data collected of a subject over time. The system 10 may include or incorporate one or more of an image capture device 20, model generator 30, database 40, model analysis unit 50, or communication network 60. The image capture device 20, model generator 30, database 40, and/or model analysis unit 50 may include a communication ports comprising a wired and/or wireless receiver, transmitter, and/or transceiver configured for direct or indirect data transfer with various components of the system 10, e.g., via the communication network 60. The communication network 60 may include one or more wired connections, wired networks, wireless networks, or the like. Networks may include any suitable data transmission network such as an intranet, internet, wide area, or local area network for transmitting data. The system components may be local or remote with respect to one another.

The image capture device 20 may be configured to capture video data of a subject, such as when the subject is positioned on mattress or other platform of a crib or bed. The image capture device 20 may include one or more cameras configured to collect video data of the subject. The one or more cameras may be positioned around the subject at a location to capture the subject. The image capture device 20 may transmit the video data directly or indirectly to the model generator 30, e.g., utilizing the communication network 60. For example, the image capture device 20 may transmit the video data to a database 40 for subsequent retrieval by the model generator 30 or may transmit the video data directly to the model generator 30.

The model generator 30 may be configured to analyze the video data to develop a working model 34 of the subject.

Developing a working model 34 may include utilizing a subject specification 32 that defines a plurality of reference points and known relationships between and/or among the reference points, such as between and/or among reference points, such as distances, direction, and/or vectors between reference points, which may include triangulation data, dimensions and/or sizes of reference points, relative locations between reference points. The system 10 may be configured to identify any combination of reference points. For example, reference points may include top of head, eyes, ears, mouth, nose, jaw, chin, neck, shoulders, elbows, hands, fingers, sternum, hips, thighs, knees, shins, ankles, feet, toes, to name a few.

The subject specifications 32 used by the model generator 30 may be general to a population of subjects or specific to the subject. For example, subject specifications 32 may comprise a specification of known relationships specific to the subject or a more general population of subjects. In various embodiments, the system 10 may utilize an initial general subject specification 32 for a subject that defines a plurality of reference points and known relationships that are generally applicable to the subject, such as subjects of similar age range, weight range, sex, measurements (e.g., head, shoulders, torso, limbs), or combination thereof. As introduced above with respect to the update operations, in one example, the system 10 may be configured to customize general subject specifications 32 over time using object detection and collected subject data to fine tune the known relationships to that of or more closely corresponding to the subject. In one example, the system 10 may initially employ object detection to generate an individualized or more individualized subject specification 32 with respect to a plurality of reference points and known relationships. In one example, the image capture device 20 may collect video data of a subject, for example when the subject is not obscured. The model generator 30 may analyze the video data, e.g., using object detection, to collect measurements of the subject that the system 10 may then use to select a subject specification 32 that corresponds to the collected measurements from a plurality of different subject specifications based on different measurements or generate a subject specification 32 specific to the subject using the collected measurements. In these or other embodiments, a user may access a user interface in communication with the model generator 30 to input one or more measurements of the subject for use in generating, selecting, and/or updating a subject specification or otherwise for use with the subject. In any of the above examples, the subject specification 32 may be continuously or periodically updated to reflect specific known relationships between two or more reference points with respect to the subject to further individualize the subject specification 32 to the subject.

The model generator 30 may identify and track the reference points over time, estimating their identities and locations as reference points coming into and out of view within image frames captured by the image capture device 20, to update the working model 34.

The model generator 30 may utilize one or more object detection algorithms that process the video data to identify objects. The object detection algorithms may be utilized to assist in reference point identification. In some embodiments, object detection algorithms incorporate known relationships. For example, a subject specification 32 may include or identify an object detection algorithm that incorporates the known relationships defined in the subject specification or provide instructions for selection, use, and/or incorporation of the known relationships in an object detection algorithm. The objects detected may include those corresponding to the subject and, in some configurations, surrounding environments. In one example, the subject specification 32 includes one or more of the object detection algorithms. In some embodiments, the model generator 30 may apply filtering, image stabilization, or other processing to the video data to improve analysis.

Using object detection, the model generator 30 may identify visible reference points (which may also be referred to herein as known reference points) in the frames of the video data. The model generator 30 may further utilize object detection to identify reference points that are not visible, e.g., reference points that are obscured from view due to orientation of the subject, clothing, or other objects. These reference points may represent estimates based on object detection and known relationships with one or more known or estimated reference points. For example, in a first image frame, the model generator 30 may identify one or more known reference points, such as those that are visible in the image frame. Using known relationships for the known reference points, the model generator 30 may determine image scale from known distances between known reference points. In some instances, the model generator 30 may utilize known measurements of length, distance, or ratios to determine image scale. Using two or more of image scale, object detection, and known relationships between and/or among the known reference points and other potential reference points defined in the subject specification 32, the model generator 30 may estimate one or more estimated reference points among the potential reference points defined in the subject specification 32 in the image frame. The extent to which the model generator 30 is able to generate such estimates will depend on the degree to which the subject is obscured. For example, if object detection can identify or estimate orientation from visibility of shoulders, legs, hips, or feet, the available known relationships are more likely to be usable to estimate a number of reference points. The visualization in this situation may be actual or deduced from outlines, contours, shadows, or the like in bedding or clothing captured in the image frame. As movement of the subject is captured in subsequent image frames, the model generator 30 may continue to utilize object detection and the known relationships to identify additional reference points, either via visualization or estimation. These known and estimated reference points are tracked in the working 34 model. While some reference points may inevitably become obscured from view by subject orientation, bed clothing, or other objects, some to the extent to where they would not be suitable for estimation otherwise, e.g., cannot be deduced by shadows, contours, or outlines in obscuring objects, may still be estimated due to a combination of two or more of their prior visualization as a known reference point, prior estimation as an estimated reference point, or known relationships with another known or estimated reference point at the time.

Reference points may be handled by the model generator 30 with respect to the working model 34 in various ways. For example, the model generator 30 may assign confidence scores to reference points that may increase or decrease in the working model 34 based on an object detection confidence score (probability the reference point is the object defined in the object detection algorithm) and known relationships with other reference points. It will be appreciated that object detection algorithms may incorporate the known relationships described herein, in which case an object detection confidence score may incorporate known relationships, such as those with closely related reference points, which may also incorporate confidence scores of the reference points having known relationships with the respective reference point. In one embodiment, confidence scores may be calculated based on object detection confidence score of the reference point and confidence scores of reference points having direct or indirect known relationships with the reference point, with the confidence scores of closely related reference points with respect to known relationships being given more weight. In some embodiments, confidence scores may also incorporate time since last visualization or establishment of the reference point or closely related reference points. Reference points are generally described herein as being known or estimated reference points. These statuses may represent confidence scores of the particular reference point being within a predefined threshold range. For example, known reference points are generally those that are clearly visible in an image frame and thus are associated with a high confidence score, occupying the top threshold range. Estimated reference points may occupy one or more lower confidence score ranges. For example, a first estimated reference point, corresponding to a knee, that is not visible but that which object detection detects as protrusion under a blanket that has known relationships with one or more second known reference points and/or estimated reference points corresponding to a foot or hip may have a confidence score within a threshold range just below that of known reference points. In some configurations, the confidence score or threshold range of the one or more second reference points may be taken into account with respect to the confidence score of the first estimated reference point. Thus, if the second reference points have a low confidence score or are within a lower confidence score threshold range, this may impact the confidence score of the first reference point. For example, if the first reference point corresponding to a knee, as in the above example, is detected by the object detection as having a known relationships with a second estimated reference point corresponding to a foot that has a low confidence score, the confidence score of the first reference point may similarly be low and associated with a lower confidence threshold range.

The present description describes embodiments wherein reference points may be associated with confidence designations. These confidence designations may be associated with confidence scores or contextual confidence, such as visualization or sufficient indirect evidence of location to establish a reference point. The reference point designations used herein include known reference point and estimated reference point. While these designations need not be associated as particular confidences, known reference points are reference points that are sufficiently visualized. Estimated reference points may include estimated reference points and points of interest wherein points of interest may be a designation associated with estimated reference points in which their location are more attenuated with respect to the known relationships with other reference points and/or object detection than estimated reference points. As noted above, as the subject moves, the confidence in the locations of the reference points incrementally improve. For example, when an estimate reference point becomes visualized, the model generator 30 validates the reference point, and the reference point is then designated a known reference point. If confidence in the location of a reference POI increases, e.g., through object detection and/or visualization or increased confidence in the location of closely related reference points, the reference POI may be established and designated as an estimated reference point. In an above or another embodiment, the estimated location of one or more reference points of interest as correlated to one or more known relationships with respect to one or more additional reference points may be averaged, which may include averaging over multiple image frames representing multiple movements of the subject and associated reference points.

A reference point that is completely obscured, for example, may be estimated based on known relationships with another reference point. If the confidence score with respect to the other reference point is low, the confidence in the location of the reference point may similarly be low and the reference point may be designated a reference POI. If the confidence score with respect to the other reference point is high, the confidence in the location of the reference point may similarly be high and the reference point may be designated an estimated reference point. As some known relationships may be weaker than others, confidence scores or confidence designations may similarly account for the strength of known relationships. For example, the system 10 may define a hierarchy of known relationships. For instance, a known relationship between a hip and a foot may be weaker than a known relationship between a foot and a knee. The model generator 30 may analyze the video data to track movement of the subject over time to improve the working model 34 with respect to the locations of reference points, e.g., as the reference points become visible, closely related reference points become visible or confidence in their predicted locations increase as to be sufficiently established, and/or object detection detects an object otherwise obscured that is associated with a threshold confidence score as to be sufficiently established.

In some embodiments, confidence designations may be associated with confidence threshold ranges as described herein. In one embodiment, confidence designations are based on visualization and sufficient correspondence with known relationships and/or object detection. In one embodiment, the system 10 applies rules with respect to estimating locations of reference points based on confidence designation of the reference point, which may include confidence designations of reference points having known relationships with the reference point. In another embodiment, the system 10 assigns confidence scores to reference points and applies the numerical scores, rather than a group designation, for one or more system operations, such as for use in estimating or establishing another reference point via known relationship with the reference point. The model generator 30 may apply rules that limit estimation reference point status. For example, a reference point designation may be demoted such that the estimated location of the reference point is deemed to not be suitable on its own, or potentially with one or more other reference points, which may also depend on their designation, to be used to estimate or establish the location of another reference point defined in the subject specification 32 in the working model 34.

In one embodiment, the model generator 30 may also be configured to work backwards with respect to an estimated reference point, such as a reference POI, being tracked. For example, if a reference POI becomes visible (validated) or established in subsequent image frames, the model generator 30 may establish the reference POI as an established reference point with respect to one or more previous location coordinates thereby back-updating the working model 34. Back-updating may similarly be used to increase confidence scores of previous coordinates in embodiments employing confidence scores.

As introduced above, the systems and methods may be configured to construct a subject model 52 corresponding to a subject from video data of the subject. Constructing a subject model 52 may include developing a working model 34 utilizing a subject specification 32. As introduced above, developing the working model 34 may include identification of known reference points, which may be sufficiently visible, and estimating locations of reference points that are not sufficiently visible. For example, the model generator 30 may be configured to leverage what is known to estimate reference points. For instance, the subject specification 32 specifies the subject is an infant, for example, and object recognition may use this information to identify known reference points such as head, eyes, nose, and shoulders that are visible in an image frame. The subject specification 32 also defines size of the subject and known relationships with respect to the known reference points and other defined reference points that are not currently known reference points. The model generator 30 may utilize the known data with respect to the known relationships between known reference points, known measurements of objects in the scene, or a combination thereof to scale the image. The model generator 30 may estimate reference points, initially as a reference POI. This may be done via a combination of object detection and known relationships between and/or among the known reference points and estimated reference points, accounting for scale. The model generator 30 may continue to process image frames over time to collect evidence. For example, the model generator 30 may track contrast and changes in the images. As the reference POI become validated and/or established, the model generator 30 may estimate additional reference POI based on their known relationships with the known reference points and established reference points, thereby developing a working model 34 over time.

Further to the above, in operation, the model generator 30 may employ object detection to identify/validate, estimate, and establish reference points. While various methodologies may be used, the model generator 30 may identify visible reference points as known reference points in the working model 34. As not all reference points may be visible, the model generator 30 may identify points or regions that are estimated to be reference points as reference POI. Object detection algorithms may be applied to captured video images to estimate the reference POI based on known relationships with other reference points. For example, object detection algorithms may be used to identify a feature in one or more video images such as a bulge, shadow, contour, outline, or profile, that the model generator 30 may estimate to be a reference point based on, for instance, an estimated distance, angle, or relative position of the feature to one or more known or estimated reference points, which in some instances may include other reference POI.

The working model 34 may be dynamic with the model generator 30 identifying and tracking known reference points and estimated reference points (established and POI) and modifying the same on an ongoing basis as tracked objects and features come into and out of view. As the subject moves, reference POI may become visible or confidence in their identity and/or location may be increased such that the system establishes the reference POI as being a known reference point when visible or estimated reference point when, for example, one or more closely related reference points with respect to the known relationships are established or known, which may additionally incorporate partial object detection of the reference POI. For example, the model generator 30 may be configured to make assumptions based on partial objects. For example, if a shadow is detected, the model generator 30 may estimate where the object making the shadow could be and then look for patterns. The subject specification 32 may specify various criteria for different objects that the one or more object detection algorithms use to identify the defined objects, which may be different for different objects. In further examples, the model generator 30 may also identify a reference POI as an established reference point when one or more closely related estimated reference points, alone or together with known reference points, are identified such that the confidence of the location of the reference point previously identified as a reference POI is at a threshold level. For example, a known reference point corresponding to a hand or wrist together with an established reference point corresponding to a shoulder may result in a reference POI corresponding to an elbow reference point being identified as an established reference point despite not being in view. Again, partial object detection, e.g., of a bulge or shadow corresponding to the estimated location of the elbow, may similarly be utilized based on the known relationships with the hand or wrist and the shoulder. As the subject moves, previously known or an established reference point may be sufficiently obscured that they are no longer considered known or established. This may arise, for instance, when if closely related known relationships are similarly obscured such that the location of the reference point cannot be estimated with sufficient certainty, in which case the reference point may be estimated as a reference POI or not at all until addition information with respect to the location of the reference point can be collected.

The location of the reference points may be tracked by the model generator 30 to develop the working model 34. The model generator 30 may translate the locations to coordinates within a coordinate space within the working model 34 or may translate the locations to coordinates from the working model 34. The analysis model 34 may provide, e.g., transmit or otherwise provide access to, the coordinates to the model analysis unit 50 for use in generating the subject model 52. In some embodiments, video may also be included. Depending on the configuration, the subject model 52 may include coordinates of known reference points, estimated reference points, only certain estimated reference points based on confidence scores, thresholds, designations, or a combination thereof. For example, in one embodiment, coordinates with respect to all reference points may be used or otherwise provide for use in the subject model 52. In some embodiments, coordinates of reference POI and/or other reference points of low confidence may not be used or otherwise provided for use in the subject model unless or until the estimated locations are sufficiently established, e.g., are associated with a threshold confidence or designation based on a period of time since the reference point was last visualized, a visualization or confidence in location of reference point having known relationship with the reference point, an object detection confidence score, or a combination thereof. In some embodiments, the subject model 52 includes coordinates of selected reference points by confidence, by identity, or both. In some embodiments, the model analysis unit 50 may be configured to render or analyze subsets of the data of the subject model 52. For example, the model analysis unit 50 may be configured such that a user or program may select certain reference points, confidence thresholds, or both from which rendering and/or analysis of the subject model includes.

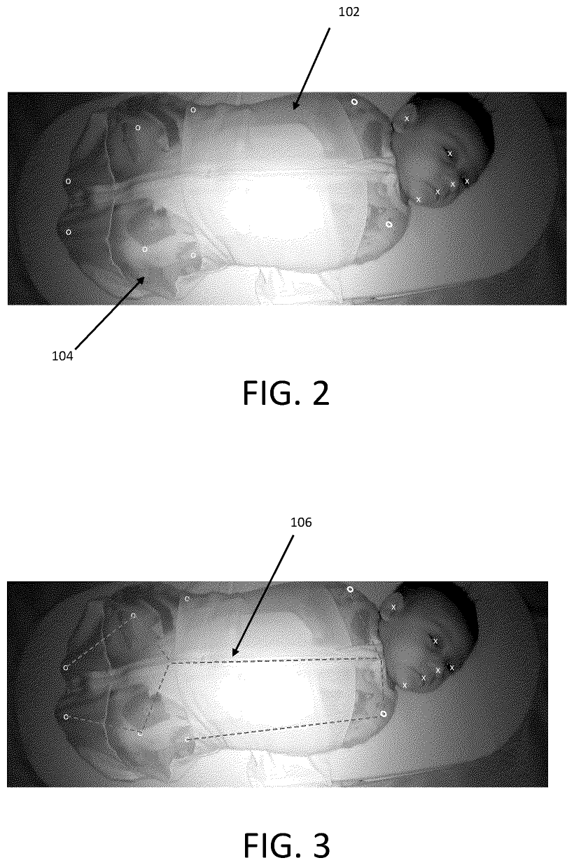

FIG. 2 illustrates a image of a subject to illustrate an aspect of a working model 34. In the image, the known reference points are marked with x's and the estimated reference points (reference POI) are marked with O's. The known reference points include eyes, ears, nose, mouth, and chin which have approximately fixed known relationships and only change minutely as the subject grows. As noted above, objects of known dimensions may be used to scale the image. In this example, the subject is in a sleep sack 102 having a lower mesh area 104 of known length. By establishing this length with respect to the image, the other dimension in the image may be calculated.

FIG. 3 illustrates an application of the known relationships to estimate the reference POI according to one embodiment. Utilizing the known distances between the known reference points, known non-subject object dimensions, or both, one or more reference POI may be estimated. In some instances, object detection may also be included in the reference point estimation. As shown, reference points corresponding to shoulders, hands, knees, and feet have been estimated as a reference POI using object detection to estimated shoulder, torso, hand, and leg lines 106 together with known relationships between the known reference points and the reference POI. The reference POI are, at this point, best guesses as they are not clearly visible. The model generator 30 may or may not perform reference POI estimation with respect to an initial image frame. However, as noted above, the process may utilize elements in the image frame(s) together with known relationships to identify reference POI. For example, a protrusion under a blanket detected by object detection may corresponded to a known relationship of a foot to a known reference point (or potentially an established reference point), which the model generator 30 may use to generate an estimated reference point (reference POI) corresponding to a foot as the region or point corresponding to the protrusion.

For example, the accuracy of reference POI may be incrementally improved as the subject moves. For example, the foot protrusion may change during movement to more clearly provide a reflection of the foot and/or reference point having known relationships with the foot may be estimated, become established, or become known to result in establishing the location of the foot. Thus, by collecting multiple samples of what is believed to be the object, statistical methods with respect to object detection and/or known relationships may be employed to establish its absolute location in reference to other reference points. By establishing reference POI together with known reference points, other reference points may be estimated via known relationships with the known reference points and/or established reference points. As the subject moves, reference POI may also become validated, if, for example, the object corresponding to the estimated reference point becomes visible or a reelection thereof is sufficiently visible.

Once sufficient reference points are known, established, and in some instances estimated, a subject model 52 can be constructed of the subject. When observing the scene, the model generator 30 may track the movements of the known and estimated reference points in working model 34. The model generator 30 may translate the reference point locations and/or movements thereof into coordinates within a coordinate space. In various embodiments, the model generator 30 may transmit or provide the coordinates, or change coordinates, as described in more detail below, of the known reference points and estimated reference points, which, depending on the configuration, may include just established reference points or both established reference points and reference POI to the database 40 or model analysis unit 50, instead of the video, for analysis. The coordinates may be coordinates in an established grid system, for example pixels of the image capture device, or vector based, for example. By sending coordinates, the amount of data is reduced. By sending change coordinates, the amount of data required is further reduced by an order of magnitude, with respect to video data, without loss of information. The data may be further reduced by only transmitting and/or storing change of coordinates when a change has occurred.

It may not always be clear as to what data represented in video data collected from a subject will be important for subsequent identification of conditions or predicting development. Accordingly, retaining a complete set of data that is available for subsequent analysis may be beneficial. Thus, in some embodiments, the video data captured by the image capture device 20 may be saved for subsequent analysis. However, storing video data collected over a significant period of time for subsequent analysis can be resource intensive. Extending this to a large population of subjects raises questions about economic feasibility. Accordingly, as introduced above, the system 10, e.g., model generator 30 or model analysis unit 50, may be configured to generate abstracted data. The abstracted data may be used, for example, to retain important data elements from the video that may not be considered important at the time of collection. For example, methodologies described herein may include tracking location and movement of one or more reference points of a subject via video analysis, e.g., as described above and elsewhere herein, and translating those locations and movements to a coordinate system. In one embodiment, the subject model 52 comprises coordinates of the subject within a coordinate system overtime corresponding to movements of the subject. In some embodiments, the model analysis unit 50 is cloud based or edge based. The model analysis unit 50 may transmit analyses to the database 40 or may output one or more portions and/or predictions (conclusions, diagnoses, conditions, or the like), thereof for viewing, which may include via a reporting unit 70.

The model analysis unit 50 may utilize reference point coordinates, which may include change coordinates (change coordinates) as described below, to generate the subject model 52 or may receive or otherwise access the subject model 52 for analysis. In some embodiments, the model analysis unit 50 may also be configured to analyze a subject model 52 including video data with reference points, or without video data. In some embodiments, execution of the subject model 52 or coordinates thereof to generated a subject model that includes a “stick figure” abstraction to reduce data storage while being able to perform analytics on the resultant model and the anonymized subjects. The model can then be used for analysis, such as analytics, AI, or machine learning, including animation and long-term tracking of movements, growth and behavior. The analysis may include populations studies. The analysis may include diagnosis or predictions with respect to medical conditions, such as autism, nervous disorders, sleeping disorders, or behavior disorders, such as those involving specific body movements, orientations, and movements. The model analysis unit 50 may be configured to analyze the subject model 52 to, for example, track growth, identify conditions or illness, and/or diagnose diseases or abnormalities. In one embodiment, the model analysis unit 50 may include or be executed by any suitable computer, such as one or more servers. The model analysis unit 50 may be local or remote with respect to the operative hardware configured to perform the operations of the model generator 30.

In various embodiments, the subject model 52 comprises a data abstracted model and constructing the subject model 52 includes plotting coordinates corresponding to reference point locations to generate a data abstracted model. The reference points may be sequenced with respect to time to correspond with locations of reference points relative to each other at particular time instances. The reference point coordinates may be applied in sequenced time sets of all reference points or just reference points undergoing relative movement since the previous time set being rendered in the model. As described in more detail below, the coordinates may comprise change coordinates (change coordinates). Abstracting the subject into a data model, without video, the system 10 may also anonymize the video data in a manner that addresses privacy concerns as the video data itself becomes unnecessary due to the maintenance of the anonymized aspects of the information represented in the video data.

The model analysis unit 50 may construct the subject model 52 from the reference point coordinates and thereafter track movements and/or growth, which may include size or measurements, of the subject over time. For example, with sufficient reference point data, such as when sufficient reference points are known and/or established, the model analysis unit 50 may be configured to take measurements from the constructed subject model to track growth, movements, and/or patterns thereof.

In one embodiment, the model analysis unit 50 is configured to generate the subject model 52 from coordinates of reference points that have been sufficiently visualized or established. As noted above, in some embodiments, the working model 34 may be dynamically updated over time. In some instances, this may result in reference points previously known or estimated (e.g., established or POI) being demoted such that their location is insufficiently known as to be unreliable with respect to use in the model. While back-updating may be employed in some instances, in others, location of some reference points may be lost over a period of time. Thus, the working model 34 may not always be able to provide a complete model rendering or coordinate set. However, as such periodic gap periods are brief, their presence may have minimal overall impact on the model and associated analysis. In one embodiment, periodic gaps in portions of the subject model 52 may be overcome by operations such as averaging between observations and/or measurements straddling such gaps. As noted above, in some embodiments, the subject model does not include low confidence estimated reference points, such as reference POI, e.g., the model generator 30 may not provide data or coordinates associated with such reference points or the model analysis unit 50 may filter out such data or coordinates. In other embodiments, the subject model 52 may include low confidence reference points, such as reference POI, which may or may not be associated with a confidence score or weight the model analysis unit 50 incorporates into analyses and/or output determinations, which may include predictions with respect to conditions. For instance, the system 10 may be configured to output determinations with confidence scores or provide output determinations filtered by selected reference point confidence or designations such that only reference points of the selected confidence range or threshold or designation are considered in the generation of the output determination. In one example, the model generator 30 may assign confidence scores or designations to coordinates of estimated reference points for points in time corresponding to the coordinates. The coordinates and confidence scores or designations may be recorded and/or transmitted to the model analysis unit 50 wherein the model analysis unit 50 may give weight within the subject model 52 to the estimated reference points based on the confidence scores or designations. In one configuration, the model analysis unit 50 may apply one or more thresholds with respect to confidence scores wherein coordinates may be excluded or weighted based on their confidence score relative to the thresholds, which in one example the thresholds may correspond to the coordinate designations.

Analysis of the subject model 52, may include tracking movements and/or growth over time, such as tracking movement or size of one or more reference points relative to one or more other reference points and analyzing the movements and/or growth for patterns to make predictions with respect to the subject, such as early diagnosis of medical conditions. In one example, the movements and/or growth may be compared to movement data and/or growth data with respect to other subjects to identify similarities and/or differences. In some embodiments, movement data may include position data, such as sleep position, in addition to data corresponding to physical movement. Knowing conditions marked by similar movements and/or growth with respect to other subjects may be used to predict corresponding conditions in the subject. In some embodiments, movement and or growth data with respect to a plurality of subjects may be utilized in population studies to better understand relationships between movements and/or growth with respect to medical conditions or development.

In any of the above analyses, additional information may be utilized with respect to a subject to improve correlation and diagnostic accuracy. For example, in addition to movement and/or measurements, other information related to the subject may be considered such as temperature, food intake, birth weight, sex, genetic history, known conditions, sleep history, family history, to name a few. Data drawing from a plurality of subjects may be used to enhance knowledge and build population models that may be used for early identification of conditions based on correlations between movements, measurements, and other information related to subjects.

In some embodiments, the model analysis unit 50 is configured to apply machine learning (ML) and/or artificial intelligence (AI) processing to subject model analysis and generate predictive outputs. For example, AI or machine learning may be used to identify patterns in movements and/or growth and correlations between sets of population data to make predictions with respect to future growth, presence of or predisposition of conditions, or the like. Artificial Intelligence entails the development of computer systems capable of performing tasks that require human intelligence, such as visual perception, sound recognition, and decision-making. These tasks need cognitive functions associated with human minds, namely learning and problem solving. The model analysis unit 50 may utilize one or more artificial intelligence levels such as reactive machine, limited memory, theory of mind, artificial narrow intelligence, artificial general intelligence, or artificial super intelligence. Deep learning (DL), for example is the one of the more accurate methods currently used in AI. Deep learning is a machine learning methodology that uses mathematical models called neural networks with large numbers of layers mimicking the human brain. Deep learning is able to extract complex hierarchal features and patterns present in large datasets. These features may then be merged together using neural networks to uncover the predictive model of the data. In various embodiments, the model analysis unit 50 utilizes deep learning including one or more neural networks. In one example, the model analysis unit 50 utilizes a convolutional neural network. The model analysis unit 50 may utilize probabilistic methods such as Markov modeling, Kalman filters, or Bayesian networks. The model analysis unit 50 may utilize supervised or unsupervised machine learning. In supervised learning, data examples along with their labels and annotations are used to train the model analysis unit 50. For example, the model analysis unit 50 may be configured to utilize support-vector networks to analyze data in supervised learning models. In unsupervised learning methods, data examples without labels and annotation may be used. In the unsupervised learning methods, the model analysis unit 50 is configured to try to find a natural grouping of the data based on features present in the data. Additionally or alternatively, the model analysis unit 50 may be configured to generate analytics based on the subject model 52. The model analysis unit 50 may coordinate analytics generation with other functional operations of the system 10. The modeling engine 30 may apply analytic modeling to identify patterns in the data and correlate the patterns to generate analytics based on the correlated patterns.

As introduced above, transmission and storage of video data is resource intensive. Accordingly, the present description describes embodiments wherein the data is abstracted to coordinates within a coordinate system. Thus, changes in location of reference points over time may be defined by change of coordinates. For example, tracking reference points and reference POI may include tracking coordinates of the reference points and reference POI over time. When a reference point or point of interest is determined to have moved, the change coordinates is recorded with respect to the working model 34 and may thus be provided or stored for purposes of the subject model 52 rather than the video data, significantly reducing the amount of data without loss of information. In various embodiments, the subject model 52, which may include abstracted data for use in construction of the subject model 52, may comprise change coordinates, which may include coordinates of a suitable coordinate system, such as those identified above and elsewhere herein, e.g., grid system, pixels, vector based, or the like. The coordinates of the subject model 52, may be transmitted, stored, or otherwise provided as change coordinates, further reducing data transmission loads and storage requirements.

In various embodiments, the system 10 may employ a running change in coordinates with respect to reference point coordinate locations. For example, reference point coordinates or changes thereto with respect to a point in time may be identified only when the coordinates changed from a previous point in time. As not all points change between all points in time or intervals thereof, change coordinates may result in a further data reduced subject model 52 without the loss of information represented in the data. In one embodiment, the subject model 52 comprises or is configured to be executed to model movement of the subject relative to time within the coordinate system wherein only reference points in which coordinates have changed since an earlier time point are run to represent the movement of the subject. In one embodiment, the model generator 30 and/or model analysis unit 50 may be configured to convert change coordinates representing a change in coordinates from a previous position into actual changed coordinates and/or vice versa.

Various change coordinate methodologies may be implemented. For example, change coordinates may identify an actual coordinate of a reference point at the respective point in time or may define a translocation instructions, e.g., steps, values, or the like, within the coordinate space from a prior coordinate location in the coordinate space that corresponds to the changed coordinate location of the reference point. For example, coordinate positions for reference points may be time sequenced and transmitted and/or stored with respect to the subject model 52 only when the coordinate position has changed since a previous coordinate position. The change coordinate may be represented as the actual coordinates such that if a reference point moved from coordinate (1, 3, 5) to (2, 4, 6), the change coordinate that is transmitted and/or stored for that reference point for respective point in time may be (2, 4, 6). The change coordinate may also be represented as a change of position that corresponds to the required coordinate change to result in the reference point obtaining a position within the coordinate system. For instance, if a change coordinate of (1, 3, 4, 5) is transmitted and/or stored in the subject model 52, this may represent a change of 1 in a first parameter (coordinate value, dimension, vector, or as otherwise defined with respect to the system 10), a change of 2 in a second parameter, a change in 4 in a third parameter, and a change in 5 in a fourth parameter relative to a previous coordinate position. In some embodiments, the model analysis unit 50 may be configured to execute the subject model 52 via change coordinates comprising actual coordinates within a coordinate system corresponding to a location of a reference point at a point in time or those representing translocation of the reference point from a previous point in time. It is to be appreciated, that a working model 34, which in some instances corresponds to the subject model 52, may be generated using change coordinates as described herein with respect to the subject model.

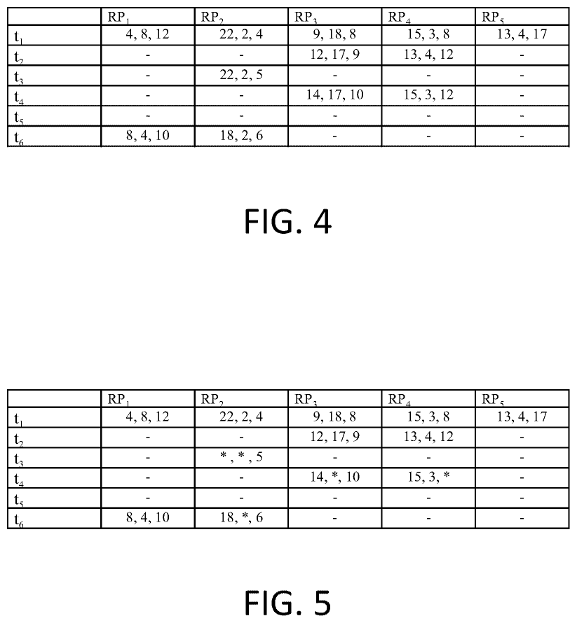

FIGS. 4&5 illustrate example change coordinates over time that may be transmitted for constructing a subject model 52 or otherwise stored for subsequent constructing of the subject model 52. The tables represents changed coordinates of five reference points (RP₁₋₅) at six points in time (t₁₋₆), with t₁ depicting an initial point in time for illustrative purposes. Each point in time may correspond to an image frame, pre-determined number of frames, period of time, or the like. Here, t₁ could represent the change coordinates for listed reference points or known coordinates of the listed reference points taken from previous change coordinates.

As shown, a 3-dimensional Cartesian coordinate system is used. However, the present disclosure is not limited to a type of coordinate system or number of dimensions defined within the coordinate system. In another example, a 2-dimensional coordinate system may be used. In the illustrated example, the change coordinates with respect to the listed reference points are identified as impacting all the dimensions defined by the coordinates representing the location of the respective reference points at a given time.

In FIG. 4, change coordinates are transmitted and/or recorded for the full set of coordinates that define the location of the reference points within the coordinate system when a change has occurred to any coordinate. For instance, RP₁ did not move between t₁ and t₅, which results in no change coordinates. However, at to, the coordinates of RP₁ changed to 8, 4, 10. These change coordinates may be stored and/or transmitted in the subject model with respect to RP₁.

In FIG. 5, less than a full set of coordinates are used to identify change coordinates of reference points when a change impacts a less than the full set of coordinates. For example, if the location of a reference point changes relative to less than all dimensions or axes, only the value with respect to the location coordinate within that dimension is transmitted and/or stored. For example, RP₂ changed coordinates from 4 to 5 with respect to the third coordinate position, which may correspond to a z-axis coordinate. This change in coordinate may, therefore, be transmitted and/or stored with respect to RP₂ at t₃. The location of RP₂ did not change again until t₆, when RP₂ changed coordinates from 22 to 18 at the first position and from 5 to 6 at the third position. As above, the change in coordinates may be transmitted and/or stored with respect to RP₂ at to. Those having skill in the art will appreciate upon reading the present disclosure, many manners of identifying the impacted coordinates may be used. As shown, an asterisk is used to identify portions of the set of coordinates that are not impacted. In some embodiments, coordinates are provided in an ordered set or matrix wherein impacted coordinates are identified by their order or presence in a set or matrix position. In one example, an impacted coordinate is identified by a symbol designation, such as subscripts, e.g., 7, to designate coordinate 7 with respect to the x-axis.

In various embodiments, the system 10 may employ a running change in coordinates with respect to reference points relative to prior coordinate locations that result in a subject model 52. For instance, the change coordinates may be executed relative to time within the coordinate system wherein each change of a coordinate or coordinates for a reference point is applied to the respective prior coordinate or coordinates for the reference points of the subject model 52 to represent movement of the subject. For example, if a reference point moves from a location along the x-axis of a defined coordinate system space from a point represented by a value of 5 to a point represented by a value of 8, the working model 34 may record and/or transmit a change coordinates value of 3. If the reference points being tracked moves from a location along the x-axis of the defined model space from the point represented by a value of 5 to a point represented by a value of −2, the working model 34 may record and/or transmit a change coordinates value of −7. Thus, the system 10 may track changes in coordinate values relative to a previous coordinate value, i.e., a change coordinate.

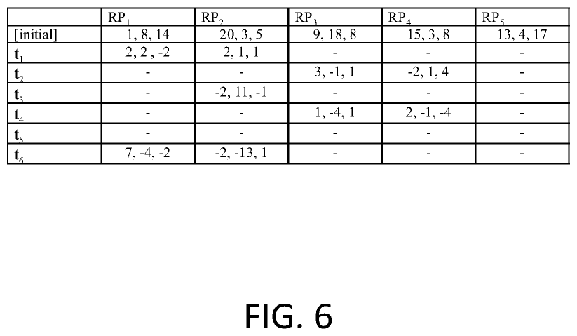

FIG. 6 illustrates and example of change coordinates over time that may be transmitted or otherwise stored for subsequent analysis of the subject model 52 wherein the change coordinates represent translocation instructions, e.g., steps, values, or the like, within the coordinate space from a prior coordinate position. The table represents changed coordinates of five reference points (RP₁₋₅) at six points in time (t₁₋₆), with t₁ depicting an initial point in time for illustrative purposes. According to this methodology, the working model 34 tracks changes in coordinates for each reference point from a prior coordinate. For example, if RP₁ undergoes a changed coordinate location at t₁ of 1 at the first position, 2 at the second position, and −2 at the third position, the system may transmit and/or store the changed coordinates with respect to RP₁ at t₁. Thus, depending on the coordinate system methodology implemented by the system 10, if the initial position of RP₁ was 1, 8, 14, the subject model 52, e.g., execution of the subject model, may move RP₁ to a coordinate location within the system corresponding to 3, 10, 12. As noted above, the coordinate system and/or change of coordinates may utilize any suitable methodology, e.g., vector based. RP₁ does not change position again until to, wherein the coordinate locations at position 1 undergoes a coordinate change of 7, position 2 undergoes a coordinate change of −4, and position 3 undergoes a coordinate change of −2. Thus, depending on the coordinate system methodology implemented by the system 10, at to the subject model 52 represents or execution of the subject model 52 may move RP₁ to a coordinated location within the system corresponding to 17, 6, 10. As above, the system 10, e.g., model generator 30 or model analysis unit 50, may be configured to record and/or transmit data corresponding to just the necessary coordinates representing or required to represent the change. Thus, if no change is required with respect to a portion or parameter of the coordinate position, the change coordinates may be only the portion required to generate the change. The transmission and/or storage of impacted coordinates and/or parameters thereof may be by any suitable methodology, such as those identified above.

While the present description generally describes such analysis of the subject model 52 as being performed on the subject model 52, the subject model 52 may generally correspond to the working model 34 at various levels of confidence as the working model 34 may be dynamic as reference points become visible or established and previously known reference points (previously visualized or indirectly established relative to closely related reference points) become obscured or unable to be sufficiently established relative to suitably known or established reference points. However, as the working model 34 improves the confidence of the reference points that are not in view increases and the resulting subject model 52 may be considered accurate as to all or certain reference point locations defined by the model, which, in one embodiment, may be determined with respect to threshold confidence level assigned by to system 10. Similarly, while the present description generally describes the subject model 52 as one that is reconstructed from the working model 34, it is to be appreciated that, in some embodiments, the working model 34 may be considered to correspond to that of the subject model 52 and be suitable for analysis as described herein with respect to the subject model 52. Thus, video, coordinates, which may include change coordinates, may be analyzed via the working model 34.

In one embodiment, the subject model 52 may include a data set comprising abstracted data represented by coordinate data, which may include change coordinate data, of various reference points. The abstracted data comprising the subject model 52 may be rendered to a visual model, handled in data, or both. For example, the abstracted data represented by coordinates/changed coordinates of a desired selection of the reference points may be rendered to create a subject model 52 comprising a stick model. In a further example or the above example, or another example, the abstracted data represented by the coordinates of a desired selection of the reference points may be analyzed in data without actual rendering. In various embodiments, above subject models may be analyzed by AI/machine learning algorithms, e.g., as described herein.

In one embodiment, coordinate data, which may include change coordinate data, may be transmitted or provided in real time for generation of the subject model 52.

As introduced above, the system may include or be in data communication with a database 40 configured to store system data. The database 40 may be local or remote with respect to the image capture device 20, processing hardware corresponding to the operations of the model generator 30, model analysis unit 50, and/or other functional units of the system 10. In some embodiments, the database 40 is cloud based or edge based. The system data may include video data, model data, data analysis, population data, coordinates, specifications, subject models, or the like. For example, the model generator 30 may transmit coordinates and/or subject models 52 to the database 40 for subsequent access by the model analysis unit 50, e.g., for rendering and/or analysis as described herein. It is to be appreciated that the model generator 30 may update or generate, in whole or in part, a subject model 52 and transmit the subject model 52 to the model analysis unit 50 for analysis. However, for ease of understanding the various operations of the system 10, the present description generally describes the operation of generating subject models 52 with respect to the model analysis unit 50. In some embodiments, the model generator 30 performs all or a portion of the operations described herein with respect to the model analysis unit 50. It is to be appreciated that the hardware implementations of the various functional units of the system 10 may be local, distributed, shared, or otherwise.

In some embodiments, the system 10 may further include a report unit 70 configured to generate a report with respect to system analyses. For example, the report unit 70 may generate a report including one or more predictions with respect to a particular subject or group of subjects. The report unit 70 may be configured to provide reports to users and/or system administrators. In some embodiments, the report unit 70 may query the database 40 for subject models 52 and/or analysis of subject models 52, which may be performed by the model analysis unit 50 and transmitted to the database 40 for storage, to output updated subject specifications 32 to be used by the model generator 30 when developing working models 34. The specification updates used to update subject specifications 32 or the updated subject specifications 32 may include updated measurements corresponding to populations of infants. For instance, the model generator 30 may utilize a generally applicable specification to initially generate the working model 34. Over time, the model generator 30 may replace the general subject specification 32 with a subject specification 32 specific to the subject or group of subjects or update the general specification 32 to become a subject specification 32 specific to the subject or group of subjects based on collected data, e.g., measurements specific to the subject or group of subject or similarly situated subjects. In some embodiments, using multiple subject specifications 32, which may include updated subject specifications 32, and the measurements included therein, criteria may be identified that increases accuracy of the general model. For example, initial measurement of head size, shoulder width, or other measurements of a subject may be used by the model generator 30 as selection criteria for an initial subject specification 32 that the model generator 30 uses while building and improving the working model 34.

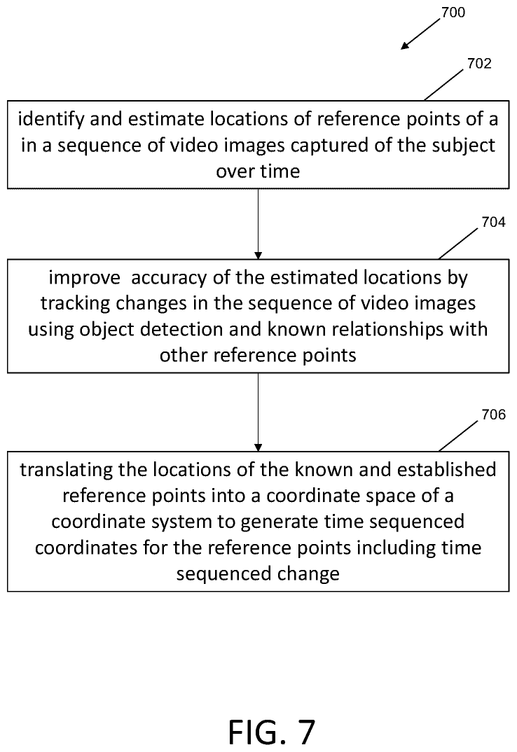

FIG. 7 illustrates a method of data abstraction and anonymization of video data 700 according to various embodiments.

The method 700 may include identifying and estimating locations of reference points of a human subject in a sequence of video images captured of the subject over time 702. According to the method 700, identification of known reference points and estimated reference points may be performed in any manner described herein, such as any of such operations described herein with respect to the model generator. For example, a subject specification that is general or specific to the subject or group of subjects may be used. Subject specifications may be individualized to the subject over time. Observations with respect to the subject may be utilized to update or specialize generalized subject specifications.

In various embodiments, certain visible reference points may be identified. For example, an eye and an ear may be visible. The system, e.g., model generator, may be configured to estimate other reference points. For instance, the location of the nose, mouth, other eye, or shoulders may be estimated, e.g., via triangulation, with the eye and ear, using the respective know relationships. Scaling may be performed, for instance, using known distances between known reference points. In some embodiments, object detection may be utilized to identify non-subject objects in image having dimensions, such as distances, lengths, angles, that are known in which are then used to scale the known relationships and/or determine dimensions of the subject and/or define a coordinate space. In one example, estimated locations may be back-updated as described herein.

The method 700 may further include improving the accuracy of the estimated locations by tracking changes in the sequence of video images using object detection and known relationships with other reference points 704. Improving accuracy may be performed according to any method described herein, such as any of such operations described herein with respect to the model generator. For example, estimated reference points of interest may be established according to any method described herein. For instance, statistical averaging of estimated location of one or more reference points of interest as correlated to one or more known relationships with respect to one or more additional reference points may be averaged, which may include averaging over multiple image frames representing multiple movements of the subject and associated reference points.

The method 700 may also include abstracting and anonymizing the video data by translating the locations of the known and established reference points into a coordinate space of a coordinate system to generate time sequenced coordinates for the reference points including time sequenced change 706. In a further example, the method 700 includes transmitting the time sequence change coordinates over a network for analysis and/or storage. The change coordinates may be according to any method described herein. For instance, in one configuration, the change coordinates comprise coordinates of the reference point within the coordinate space at specified times within the time sequence. In one configuration, the change coordinates comprise a translocation instructions within the coordinate system space from a prior coordinate location with the coordinate space. Any suitable coordinate system may be used, such as any of those described herein. For example, the coordinate system may comprise a grid system, a vector based system, or a grid system is based on pixels of an image sensor, digital camera, or digital image.

In any of the above examples or another example, the method 700 may include constructing a subject model from the time sequenced change coordinates. Constructing a subject model may be performed in any manner described, such as with respect to any of such operations described herein with respect to the model analysis unit. In one example, the subject model comprises a stick figure abstraction. In this or another example, the method 700 may include analyzing the subject model to track movements, growth, behavior, or combination thereof. For example, the subject model may be used for analysis, such as analytics, AI, or machine learning, including animation and long-term tracking of movements, growth and behavior. In a further or another example, the method 700 may include applying AI or machine learning to subject models of a population of subjects for early detection of conditions. The analysis may include populations studies. The analysis may include diagnosis or predictions with respect to medical conditions, such as autism, nervous disorders, sleeping disorders, or behavior disorders, such as those involving specific body movements, orientations, and movements. For example, the method 700 may include operation described above with respect to the model analysis unit, such as analysis of the subject model to, for example, track growth, identify conditions or illness, and/or diagnose diseases or abnormalities.

In any of the above examples or another example, the method 700 may include applying confidence scores to the estimated locations of the estimated reference points. Confidence scores may include confidence designations and may be applied in any manner described herein.

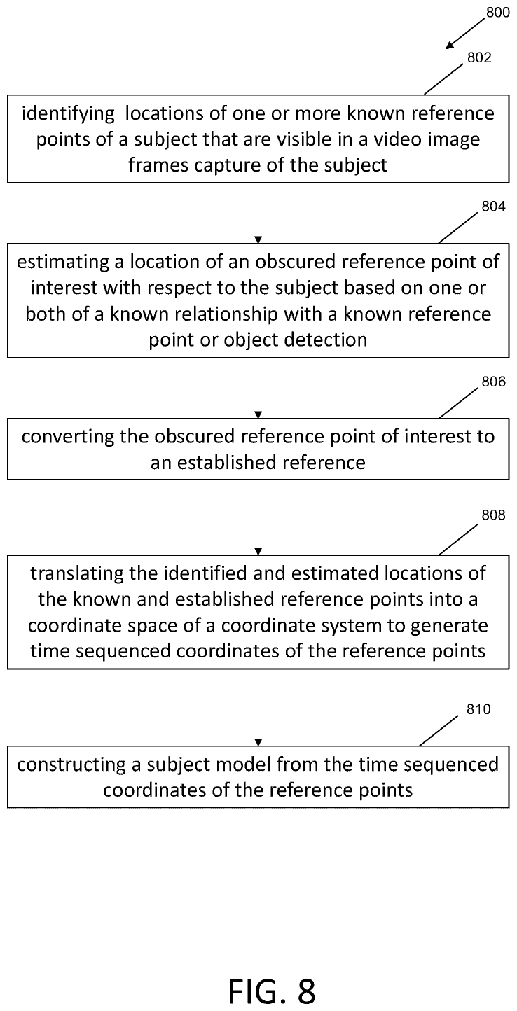

FIG. 8 illustrates a method 800 of data abstraction and anonymization of video data according to various embodiments.

The method 800 may include identifying locations of one or more known reference points of a subject that are visible in a video image frames capture of the subject 802. Know reference points may be identified by any manner described herein, such as those described with respect to the model generator. In one example, object detection may be utilized, which may be in further combination with the subject specification. Any of the various operations of the subject specifications described herein may also be included.

The method 800 may also include estimating a location of an obscured reference point of interest with respect to the subject based on one or both of a known relationship with a known reference point or object detection 804. According to the method 800, estimating reference points may be performed in any manner described herein, such as any of such operations described herein with respect to the model generator. For example, a subject specification that is general or specific to the subject or group of subjects may be used. Subject specifications may be individualized to the subject over time. Observations with respect to the subject may be utilized to update or specialize generalized subject specifications. Object recognition may be used in combination with known relationships. The system, e.g., model generator, may be configured to estimate other reference points. For instance, the location of the nose, mouth, other eye, or shoulders may be estimated, e.g., via triangulation, with the eye and ear, using the respective know relationships. Scaling may be performed, for instance, using known distances between known reference points. In some embodiments, object detection may be utilized to identify non-subject objects in image having dimensions, such as distances, lengths, angles, that are known in which are then used to scale the known relationships and/or determine dimensions of the subject and/or define a coordinate space. In one example, estimated locations may be back-updated as described herein.

The method 800 may also include converting the obscured reference point of interest to an established reference point 806. Converting to the establish reference point may include improving the accuracy of the estimated location in any manner described herein, such as by tracking changes in subsequently captured video image frames of the subject and applying one or more statistical methods to establish the estimated location relative to one or more other established location reference points, known reference points, or both. In a further example, the method 800 may include estimating locations for a plurality of obscured reference points of interest based on known relationships with known reference points, established reference points, or both. The estimated locations may be translating into time sequenced coordinates with the coordinate space comprising time sequenced change coordinates.

The method 800 may also include, translating the identified and estimated locations of the known and established reference points into a coordinate space of a coordinate system to generate time sequenced coordinates of the reference points 808. The coordinate system may include any coordinate system, such as those described herein. For example, the coordinate system includes a grid system or a vector based system. In one example, the coordinate system includes a grid system and the grid system is based on pixels of an image sensor, digital camera, or digital image.

The method 800 may also include constructing a subject model from the time sequenced coordinates of the reference points 810. Constructing a subject model may be performed in any manner described, such as with respect to any of such operations described herein with respect to the model analysis unit. In one example, the subject model comprises a stick figure abstraction.

In one example, the time sequenced coordinates include time sequenced change coordinates. Any change coordinates may be used, such as any of those described herein. In one configuration, the change coordinates over a network for analysis and/or storage. In any of the above examples or another example, the coordinates include coordinates of the reference point within the coordinate space at specified times within the time sequence. In any of the above or another example, the change coordinates include a translocation instructions within the coordinate system space from a prior coordinate location with the coordinate space.

In any of the above examples or another example, the method 800 may include analyzing the subject model to track movements, growth, behavior, or combination thereof. For example, the subject model may be used for analysis, such as analytics, AI, or machine learning, including animation and long-term tracking of movements, growth and behavior. In a further or another example, the method 800 may include applying AI or machine learning to subject models of a population of subjects for early detection of conditions. The analysis may include populations studies. The analysis may include diagnosis or predictions with respect to medical conditions, such as autism, nervous disorders, sleeping disorders, or behavior disorders, such as those involving specific body movements, orientations, and movements. For example, the method 800 may include operation described above with respect to the model analysis unit, such as analysis of the subject model to, for example, track growth, identify conditions or illness, and/or diagnose diseases or abnormalities.

In one embodiment, the system 10 may be configured to execute the operations described above with respect to method 700 or method 800. Additionally or alternative, the system 10 may be configured to perform the variations of steps of method 700 or method 800 described herein with respect to the image capture device 20, model generator 30, subject specification 32, working model 34, database 40, model analysis unit 50, subject model 52, and/or report unit 70.

In any example system or method herein, such as system 10 and methods 700, 800, if there is a need to capture images of multiple subjects, the system and methods may be configurated to incorporate face recognition to distinguish between the different subjects to label the data and more precisely direct the known relationships.

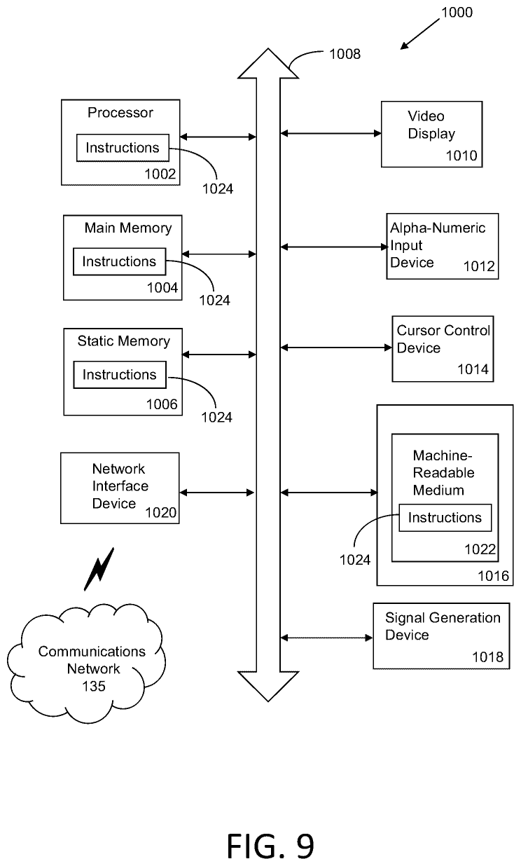

Referring now also to FIG. 9, at least a portion of the methodologies and techniques described with respect to the exemplary embodiments of the system 10 can incorporate a machine, such as, but not limited to, computer system 1100, or other computing device within which a set of instructions, when executed, may cause the machine to perform any one or more of the methodologies or functions discussed above. The machine may be configured to facilitate various operations conducted by the system 10. For example, the machine may be configured to, but is not limited to, assist the system 10 by providing processing power to assist with processing loads experienced in the system 10, by providing storage capacity for storing instructions or data traversing the system 10, or by assisting with any other operations conducted by or within the system 10. As another example, the computer system 1100 may assist with generating working models associated with one or more of identifying, estimating, validating, or establishing reference points; processing or defining reference points and/or known relationships; executing, defining, and/or updating object detection algorithms; image scaling; dimensioning operations with respect to images, working model, and/or coordinate determinations; selecting, generating, executing, and/or updating subject specifications; translating, handling, transmitting, receiving, applying, and/or rendering of change coordinates; analysis of subject models; communication network operations; data processing and/or data transmission scheduling; report generation; or a combination thereof, present in an environment being monitored by the system 10.

In some embodiments, the machine may operate as a standalone device. In some embodiments, the machine may be connected to and assist with operations performed by other machines and systems, such as, but not limited to, any functionality, generator, adjuster, engine executor, of other functionality described herein, any of which may be provided by such other machines or systems to the machine for use by system 10 in performance of the operations described herein. The machine may be connected with any component in the system 10. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1100 may include a processor 1102 (e.g., a central processing unit (CPU), a graphics processing unit (GPU, or both), a main memory 1104 and a static memory 1106, which communicate with each other via a bus 1008. The computer system 1100 may further include a video display unit 1110, which may be, but is not limited to, a liquid crystal display (LCD), a flat panel, a solid state display, or a cathode ray tube (CRT). The computer system 1100 may include an input device 1112, such as, but not limited to, a keyboard, a cursor control device 1114, such as, but not limited to, a mouse, a disk drive unit 1116, a signal generation device 1118, such as, but not limited to, a speaker or remote control, and a network interface device 1120.

The disk drive unit 1116 may include a machine-readable medium 1122 on which is stored one or more sets of instructions 1124, such as, but not limited to, software embodying any one or more of the methodologies or functions described herein, including those methods illustrated above. The instructions 1124 may also reside, completely or at least partially, within the main memory 1104, the static memory 1106, or within the processor 1102, or a combination thereof, during execution thereof by the computer system 1100. The main memory 1104 and the processor 1102 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 1122 containing instructions 1124 so that a device connected to the communications network 135, another network, or a combination thereof, can send or receive voice, video or data, and communicate over the communications network 1135, another network, or a combination thereof, using the instructions. The instructions 1124 may further be transmitted or received over the communications network 1135, another network, or a combination thereof, via the network interface device 1120.

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A method comprising:
identifying and estimating locations of reference points of a human subject in a sequence of video images captured of the subject over time;
improving the accuracy of the estimated locations by tracking changes in the sequence of video images using object detection and known relationships with other reference points; and
translating the locations of the known and established reference points into a coordinate space of a coordinate system to generate time sequenced coordinates for the reference points, wherein the time sequence coordinates comprise time sequenced change coordinates.

2. The method of claim 15, further comprising transmitting the time sequence change coordinates over a network for analysis and/or storage.

3. The method of claim 2, wherein the time sequenced change coordinates comprise coordinates of the reference point within the coordinate space at specified times within the time sequence.

4. The method of claim 2, wherein the time sequenced change coordinates comprise a translocation instructions within the coordinate system space from a prior coordinate location with the coordinate space.

5. The method of claim 1, wherein the coordinate system comprises a grid system, a vector based system, or a grid system is based on pixels of an image sensor, digital camera, or digital image.

6. The method of claim 1, further comprising constructing a subject model from the time sequenced change coordinates.

7. The method of claim 6, wherein the subject model comprises a stick figure abstraction.

8. The method of claim 7, further comprising analyzing the subject model to track movements, growth, behavior, or combination thereof.

9. The method of claim 7, further comprising applying AI or machine learning to subject models of a population of subjects for early detection of conditions.

10. The method of claim 1, further comprising applying confidence scores to the estimated locations of the estimated reference points.

11. A machine-readable medium carrying machine readable instructions, which when executed by a processor of a machine, causes the machine to carry out the method of claim 1.

12. A system comprising a processor and memory comprising instructions that when executed by the processor causes the system to perform the operations of claim 1.

13. A system configured for data abstraction and anonymization of video data, the system comprising:
a processor and memory that when executed by the processor cause the processor to perform the operations comprising:
identifying, with a model generator, locations of one or more known reference points of a human subject visible in one or more video image frame captured of the subject;
estimating a location of an obscured reference point of interest with respect to the subject based on one or both of a known relationship with a known reference point or object detection;
converting the obscured reference point of interest to an established reference point by improving the accuracy of the estimated location by tracking changes in subsequently captured video image frames of the subject and applying one or more statistical methods to establish the estimated location relative to one or more other established location reference points, known reference points, or both;
translating the identified and estimated locations of the known and established reference points into a coordinate space of a coordinate system to generate time sequenced coordinates of the reference points; and
constructing, with a model analysis unit, a subject model from the time sequenced coordinates of the reference points.

14. The system of claim 13, wherein the time sequenced coordinates comprise time sequenced change coordinates.

15. The method of claim 14, wherein the operations further comprise transmitting the time sequence change coordinates over a network for analysis and/or storage.

16. The system of claim 15, wherein the time sequenced change coordinates comprise coordinates of the reference point within the coordinate space at specified times within the time sequence.

17. The system of claim 15, wherein the time sequenced change coordinates comprise a translocation instructions within the coordinate system space from a prior coordinate location with the coordinate space.

18. The system of claim 17, wherein the operations further comprise:
estimating locations for a plurality of obscured reference points of interest based on known relationships with known reference points, established reference points, or both; and
translating the estimated locations of the estimated reference points of interest into time sequenced coordinates with the coordinate space comprising time sequenced change coordinates.

19. The system of claim 13, wherein the coordinate system comprises a grid system or a vector based system.

20. The system of claim 13, wherein the coordinate system comprises a grid system and the grid system is based on pixels of an image sensor, digital camera, or digital image.

21. The system of claim 13, wherein the operations further comprise analyzing the subject model to track movements, growth, behavior, or combination thereof.

22. The system of claim 13, wherein the operations further comprise applying AI or machine learning to subject models of a population of subjects for early detection of conditions.

23. The system of claim 13, wherein the operations further comprise identifying a non-subject object having a known dimension in the video image frames to scale the image frames.

24. The system of claim 13, wherein the subject model comprises a stick figure abstraction.

25. The system of claim 13, wherein the one or more statistical methods includes averaging the estimated location as correlated to the known relationships

26. The system of claim 13, wherein the operations further comprise applying confidence scores to the estimated locations of the established reference points, estimated reference points of interest, or both.
